(19) United States
(12) Patent Application Publication
(10) Pub. No.: US 2012/0054489 A1
(43) Pub. Date: Mar. 1, 2012

(54) Method and system for database encryption

(75) Inventor: Stephen Lange Ranzini, Ann Arbor, MI (US)

(73) Assignee: University Bank

(21) Appl. No.: 12/805,937

(22) Filed: Aug. 25, 2010

(51) Int. Cl. H04L 29/06; G06F 17/30

(52) U.S. Cl. 713/165

(57) ABSTRACT

The present disclosure is directed to a method for database encryption, which includes maintaining a database having fields and storing one or more data elements in a location associated with an IP address, wherein the IP address is 128 bits or greater and wherein the location of the IP address is remote from the location at which the database is maintained. The method may include storing, in at least one field of the database, a reference including an IP address corresponding with at least one of the data elements. In addition, the method may include retrieving the reference responsive to a request received from a user. Further, the method may include engaging a security layer around the data element, including performing at least one security check according to a security protocol, and determining whether to grant access to the at least one data element based on the security protocol.

### FIELD OF THE INVENTION

The present disclosure is directed to methods and systems for database encryption and, more particularly, to methods and systems for database encryption including storing one or more data elements in a remote location associated with a 128-bit Internet Protocol (IP) address.

### BACKGROUND

With the vast expansion of electronic records, the requirements of database management systems, in terms of data handling capabilities as well as security, have increased substantially. There is a movement towards data encrypting and role based access control of data, so that access to data is permitted only to those individuals who are authenticated and authorized to access the data. Massive databases that are encrypted require a large amount of continuous maintenance to load balance, since data is often added to the database in large chunks and servers can only hold a finite amount of data and certain sectors of data on some servers receive more requests for data retrieval than average. In order to manage these load balancing problems, either data must be moved or the data servers on which the data is stored must be moved.

One possible solution may be to store data in locations remote from the actual database and, instead of storing data within the fields of the database, storing an IP address in each of the data fields, wherein the IP address is the address corresponding with the location of the data. However, the most widely implemented version of Internet Protocol, Internet Protocol version 4 (IPv4), uses 32-bit (four-byte) addresses, which limits the address space to 4,294,967,296 (2³²) possible unique addresses is insufficient. This limitation already has caused developers to implement solutions and work-arounds to avoid running out of addresses as Internet use and data storage requirements increase at an extremely fast pace. In addition, security of large databases is increasingly compromised, with insiders responsible for approximately 70% of information theft.

The present disclosure is directed to improvements in database encryption in view of problems such as those discussed above.

### BRIEF SUMMARY

In one aspect, the present disclosure is directed to a method for database encryption. The method may include maintaining a database having fields and storing one or more data elements in a location associated with an Internet Protocol (IP) address, wherein the IP address is 128 bits or greater and wherein the location of the IP address is remote from the location at which the database is maintained. The method may also include storing, in at least one field of the database, a reference including an IP address corresponding with at least one of the one or more data elements. In addition, the method may include retrieving the reference responsive to a request received from a user. Further, the method may include engaging a security layer around the at least one data element corresponding with the reference, including performing at least one security check according to a security protocol, and determining whether to grant access to the at least one data element corresponding to the reference based on the security protocol.

In another aspect, the present disclosure is directed to a database encryption system. The system may include a memory having program code stored therein and a processor operatively connected to said memory for carrying out instructions in accordance with said stored program code. The program code may include instructions, executable by said processor, for maintaining a database having fields. The program code may further include instructions for storing one or more data elements each in a location associated with an Internet Protocol (IP) address, wherein the IP address is 128 bits or greater and wherein the location of the IP address is remote from the location at which the database is maintained. Also, the program code may include instructions for storing, in at least one field of the database, a reference including an IP address corresponding with at least one of the one or more data elements. In addition, the program code may include instructions for retrieving the reference responsive to a request received from a user. The program code may include instructions for engaging a security layer around the at least one data element corresponding with the reference, including performing at least one security check according to a security protocol, and determining whether to grant access to the data element corresponding to the reference based on the security protocol.

In another aspect, the present disclosure is directed to a method for database encryption. The method may include maintaining a database having fields and storing one or more data elements in a location associated with an Internet Protocol (IP) address, wherein the IP address is 128 bits or greater and wherein the location of the IP address is remote from the location at which the database is maintained. The method may also include storing, in at least one field of the database, a reference including an IP address corresponding with at least one of the one or more data elements. In addition, the method may include retrieving the reference responsive to a request received from a user. Further, the method may include engaging a security layer around the at least one data element corresponding with the reference, including performing at least one security check according to a security protocol, and determining whether to grant access to the at least one data element corresponding to the reference based on the security protocol. Also, the method may include granting access to the data element when the user requesting access to the data element satisfies the at least one security check, wherein, when the user satisfies the at least one security check, the granting of access to the data element is performed in a manner such that the transition from the access attempt to the grant of access, including execution of the security check, is imperceptible to the user.

### BRIEF DESCRIPTION OF THE DRAWINGS

FIG. 1 is a schematic illustration of an exemplary embodiment of the disclosed database encryption system;

FIG. 2 is a flowchart illustrating an exemplary disclosed method of database encryption;

FIG. 3 is a schematic representation of exemplary database maintenance functions;

FIG. 4 is a schematic representation of hardware elements that may be implemented in storing data elements in accordance with exemplary embodiments of the disclosed database encryption system;

FIG. 5 is a schematic representation of exemplary processes by which references may be stored in fields of a database in accordance with exemplary embodiments of the disclosed database encryption system;

FIG. 6 is a schematic representation of exemplary processes involved in retrieving a reference stored in a database field;

FIG. 7 is a schematic representation of exemplary processes invoked by engaging a security layer around a data element;

FIG. 8 is a schematic representation of exemplary processes involved in determining whether to grant access to a data element;

FIG. 9 is a schematic representation of exemplary processes involved in granting access to a data element; and

FIG. 10 is a schematic representation of exemplary processes involved in transferring payments related to use of the disclosed database encryption system.

### DETAILED DESCRIPTION OF THE INVENTION

The present application is directed to a database encryption system, wherein each data element in a database may be assigned to a unique, 128-bit (or greater) IP address (e.g., according to IPv6) residing on a host at a remote location. In some embodiments, the fields of the database may only contain the IP addresses of the location where the actual data is stored. In some embodiments, these IP addresses never need to change (although they easily could be changed).

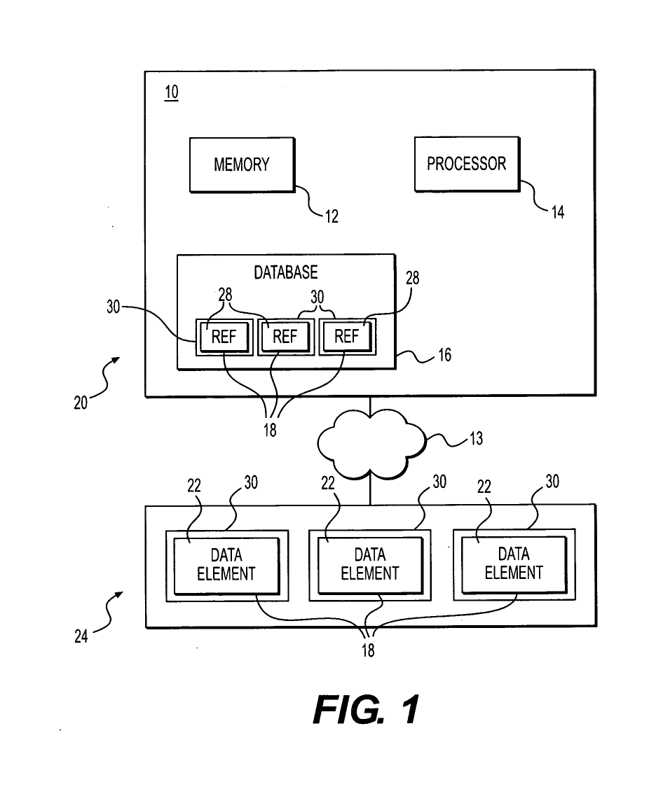

As shown in FIG. 1, certain embodiments of the present disclosure are directed to a database encryption system 10. System 10 may include a memory 12 having program code stored therein and a processor 14 operatively connected to memory 12 for carrying out instructions in accordance with the stored program code. System 10 may be implemented over a network 13, such as the Internet, by storing instructions serially or in parallel in memory systems across multiple, remote computing devices connected by a network, whether wired or wireless.

In some embodiments, the program code stored in memory 12 may include instructions, executable by processor 14, for maintaining a database 16 having fields 18. Database 16 may be maintained at a first location 20, e.g., on a server or local network. The program code may further include instructions for storing one or more data elements 22 in a second location 24 associated with an Internet Protocol (IP) address, wherein the IP address is 128 bits or greater and wherein the location of the IP address is remote from the first location at which database 16 is maintained.

The term “data field” is used in the present application in accordance with its usual meaning in the art of computer science. In certain embodiments, a “data field” is the smallest subdivision of stored data that can be accessed. A data field can be used to store, for example, numerical information such as price, count, a date or time, a date and time, etc. A pair of data fields can be used in combination to hold a geo-spatial coordinate. Also, a data field can be used to hold a block of text. Thus, a data field is a repository within which a piece of data (herein referred to as a “data element”) may be stored. For example, a data field may hold a single fact, such as a name, date, etc. Some kinds of data may be stored in either a single data field or multiple fields. For example, a date can be stored in a single “date” field, or three separate fields, namely, “month,” “day,” and “year.” The term “data element,” as used in the present application, refers to information that is stored in a data field.

The term data field may refer to data repositories within a database. In certain embodiments of the present application, however, the disclosed database encryption system may include data fields within a database, as well as data fields associated with the database that actually reside in locations remote from the database with which they are associated.

The term “remote location” as used herein, refers to a data storage memory at a location that is outside the local network on which a database is maintained. In most cases, the remote location will be at a different physical/geographical location (e.g., a different facility) than the database with which it is associated. However, to the extent a data storage location may exist at the same physical/geographical location as a database but not on the same local network, the data storage location may be considered “remote” from the database consistent with embodiments of the present application.

Referring again to FIG. 1, the program code may include instructions for storing, in each field 18 of database 16, a reference 28 including an IP address corresponding with at least one of data elements 22. The program code may also include instructions for retrieving reference 28 responsive to a request by a user, engaging a security layer 30 around the data element, including performing at least one security check according to a security protocol, and determining whether to grant access to data element 22 corresponding to reference 28 based on the security protocol. Security layer 30 may exist about data fields 18 within database 16 (i.e., around references 28) and/or about fields 18 at second location 24, in which data elements 22 are stored.

Each reference 28 may include an IP address in accordance with an Internet Protocol which utilizes addresses that are at least 128-bits, such as Internet Protocol version 6 (IPv6). An Internet protocol that uses 128-bit addresses supports 2¹²⁸ (about 3.4×10³⁸) addresses. This represents approximately 5×10²⁸ (roughly 2⁹⁵) addresses for each of the roughly 6.8 billion (6.8×10⁹) people alive worldwide in 2010. Therefore, there are enough 128-bit IP addresses to assign each data element or group of data elements of very large databases a unique IP address to serve as a reference stored in the fields of the database, while the data elements are stored at one or more remote locations.

Network Address Translation (NAT) is one type of technology to alleviate the problem of IPv4 address exhaustion. However, NAT gateways may also be implemented in system 10, even though an Internet protocol using 128-bit addresses may be implemented and address exhaustion is not a concern. In system 10, NAT gateways may provide a layer of security by, for example, masking the actual addresses at which data elements are stored, and revealing only a single address for all data elements stored at a given remote location. Therefore, in system 10, the location or locations in which one or more data elements 22 are stored may reside behind a NAT gateway.

The security protocol may be based on one or more directives including rules based on users' roles, authorities, credentials, etc. In some embodiments, security layer 30 may be based on XML. For example, security layer 30 may include a Security Assertion Markup Language (SAML) wrapper.

Performing at least one security check may include checking the authentication status of the user requesting access to the data element, checking the role of the user requesting access to the data element, and/or checking the authorization status of the user requesting access to the data element. The program code may further include instructions for granting access to the data element if the user requesting access to the data element satisfies the security check(s).

When the user satisfies the at least one security check, the granting of access to the data element may be performed in a manner such that the transition from the access attempt to the grant of access, including execution of the security check, is imperceptible to the user. For example, the security check may be run in the background, without any on-screen display related to the security check, unless the user fails a security check. If the user satisfies all security checks, system 10 may display the information sought to be accessed by the user, without any additional input from the user. In some embodiments, additional security checks may be run, which may require further input from a user (e.g., a login and password, etc.). For example, a first security check(s) may be run with respect to database 16, and a second security check(s) may be run depending on the storage location and nature of the information sought by the user. Highly sensitive information may be protected by additional layers of security.

In addition, the program code may further include instructions for associating a human readable reference ID with one or more data elements, and displaying the reference ID to users instead of the IP address with which each data element is associated. For example, the reference ID may be a descriptive name readily recognizable by the user, e.g., “Patient Name.” In some embodiments, the program code may include instructions for establishing and maintaining a reference ID chosen by a user. For example, the program code may include instructions for running functions that enable a user to create and maintain a customizable database, e.g., to store information related to a small business, such as a doctor's office. Such a database may be customizable to record health data of patients. To provide users with flexibility, the user may be able to select the reference ID for certain data elements that describes the type of measures for which the patients' health is recorded.

Since system 10 enables data to be stored in remote locations, in some embodiments, the program code may further include instructions for transferring a payment to an entity who hosts one or more data elements on behalf of an entity who maintains the database with which the one or more hosted data elements are associated. For example, system 10 may utilize a micropayment system to pay for storage space and/or CPU operating time at remote locations, or a fee per data field retrieved.

In addition, yet another layer of security may be provided by, for example, network security solutions. For example, a number of products are commercially-available (such as Promia's Raven and Owl™ products) for providing security around Linux-based networks. Such products could provide security around the entire database network of the disclosed database encryption system, including its nodes. Each database element with its unique IP address would essentially be a node. With this configuration, the database elements would not need to be in one spot to be secured, and they can be distributed across one or more remote locations, as long as they are addressable from the Internet via an IP address.

As discussed above, one problem with large databases is the need for load balancing, where the distribution of data within the database is rebalanced. With large databases, this may be required frequently, or even constantly in some cases. Since, according to the disclosed system, the database itself could contain IP addresses indicating where the actual data is located, load balancing would be more easily maintained in the database. Further, to the extent the data center needs to rebalance data flows due to demand patterns in accessing the data contained in the database to optimize the database access speed, the physical locations of the data (e.g., remote servers, SANs, etc.) can be changed on the fly as needed, in order to add storage locations/data or move data.

As also discussed above, a significant problem with IPv4 is IP address exhaustion. By leveraging IPv6 technology, issues such as IP address exhaustion and other problems discussed above can be avoided and the ongoing daily maintenance cost of maintaining a large database can be greatly reduced.

In addition, the disclosed database encryption system may provide enhanced security for data. First, IPv6 has more security built into it than IPv4, especially for mobile applications. Further, according to the disclosed system, additional layers of security can be added to a database by putting a security layer around data elements and data groups in a database. For example, a Security Assertion Markup Language (SAML) wrapper, or other XML-based security layer, could be implemented to secure the data. According to one embodiment of the disclosed system, the security layer, in whatever form of XML, could control access based on authorities and would be inseparable from the data, so that no matter where the data went in the Internet cloud, the data could still be protected by the security layer, and, in order to access it, a user would need to be authenticated to the requirements of the security layer and authorized to access the data.

The disclosed database encryption system may be applicable for storing any type of data, and may be implemented to facilitate the management of large databases, e.g., records for large entities, such as banking, government, military, healthcare, insurance, and corporate organizations, etc.

Possible applications for the disclosed database encryption system may include national defense databases, such as, for example, intelligence records databases. The disclosed system may facilitate the integration and/or sharing of data across multiple agencies. The disclosed system may enable agencies to maintain control of their own data, while facilitating data sharing. Further, by storing data at one or more locations remote from the database, intelligence agencies may increase the security protecting their data, for example, by significantly limiting the amount of information that can be retrieved by any unauthorized breach of security. In systems where data is stored in a central location, a security breach may leave large amounts of data vulnerable to the intruder. However, if the data elements are stored in individual, remote locations, many different security breaches must be completed in order to collect any meaningful data. Thus, a distributed database with individually encrypted data fields is more robust against attacks, since the data contained in a data field or fields may be unintelligible without an index indicating the interrelation of the data in multiple fields. Additional security may be provided by utilizing storage addresses chosen at random, as opposed to using sequential remote IP addresses.

By utilizing a common encryption methodology, systems of multiple databases may interoperate. The federal government has implemented a government-wide identity, credential and access management (ICAM) program, under which a common authentication system is already in place called the Federal Public Key Infrastructure (PKI). The PKI encompasses Certification Authorities (CAs) from multiple vendors supporting different PKI policies and functions, including the Federal Bridge Certification Authority (FBCA or “Federal Bridge”) and the Common Policy Framework.

In order to implement interagency data sharing using the disclosed database encryption system the agencies may engage in a policy agreement regarding roles and authorities, and reach consensus on standard data definitions (e.g., what type of data and format will be associated with each type of data field in the databases.

Another application for the disclosed database encryption system may include information management within supply chains. The disclosed system may facilitate management of which entities within a supply chain are allowed to access which information, such as how many units are being delivered by a given supplier. Another example may be limiting access for predetermined periods of time. For example, a bidder may be granted temporary access to certain CAD drawings for a finite period of time (e.g., seven days) during a bidding process. Exemplary industries that commonly operate on a supply chain include automotive manufacturing, computer chip manufacturing, the forestry/lumber industry, etc:

In addition to facilitating data sharing, the disclosed database encryption system may also provide other advantages. For example, embodiments of the disclosed system can provide efficiencies by sharing data in a common format. In addition, it may also be possible to share data at different price points for different entities. Different pricing may be automatically retrieved based on users' rules-based security access and authority, and/or other factors. For example users at large corporations or government entities might be charged a higher fee while users in an academic environment might be charges a lesser fee. In addition, it may also be possible to configure the disclosed system such that the users have authority to access the remotely-stored data while the database administrators may not.

Another application of the disclosed system may include a for-profit, opt-in network where PC owners are paid for hosting portions of the secure database in physically secure or physically insecure environments (e.g., when the data does not need to be secure). Companies and/or consumers could receive payment to store, on their own networked servers, data from another entity's database. CPU time usage could be paid for using, for example, a micropayment system.

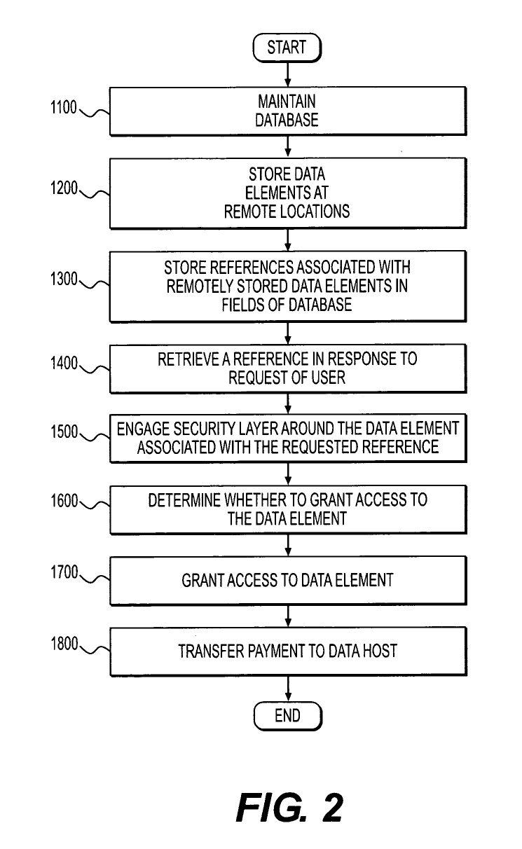

An exemplary disclosed method for database encryption is illustrated in FIG. 2. The method may include maintaining a database having fields. (Step 1100). In addition, the method may include storing one or more data elements in a location associated with an Internet Protocol (IP) address, wherein the IP address is 128 bits or greater and wherein the location of the IP address is remote from the location at which the database is maintained. (Step 1200.) In addition, the method may include storing, in each field of the database, a reference including an IP address corresponding with at least one of the one or more data elements. (Step 1300.)

The method may include retrieving the reference responsive to a request received from a user (step 1400), and engaging a security layer around the data element (step 1500), including performing at least one security check according to a security protocol (step 1510; see FIG. 7). Also, the method may include determining whether to grant access to the data element corresponding to the reference based on a security protocol. (Step 1600.) The method may further include granting access to the data element if the user requesting access to the data element satisfies the at least one security check. (Step 1700.)

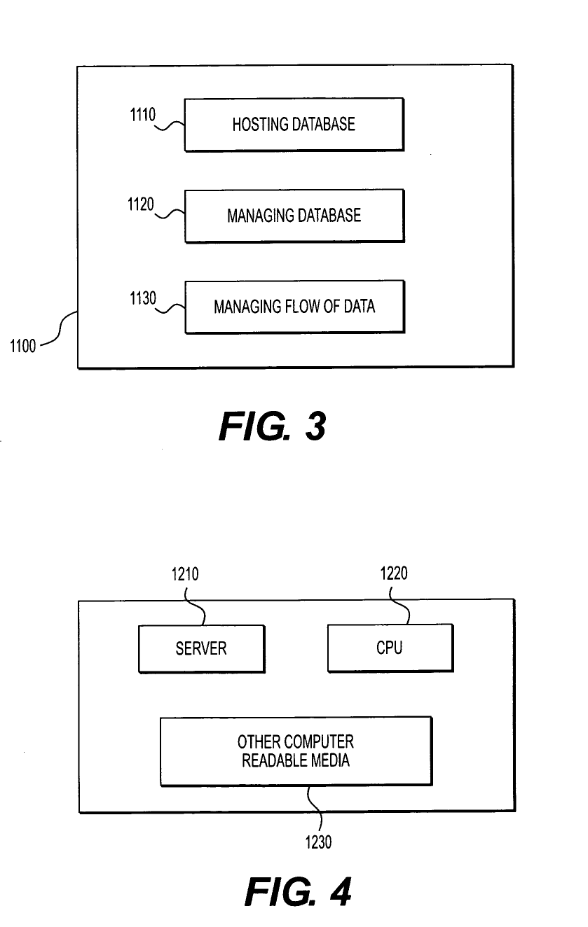

FIG. 3 is a schematic representation of exemplary database maintenance functions. Maintaining a database (step 1100) may include, for example, hosting a database (step 1110), managing access to the database (step 1120), and/or managing flow of data to, from, and within the database (step 1130). In certain embodiments, these and other functions of the disclosed database encryption system may be performed using a database management system (DBMS), which may include instructions for performing the functions disclosed herein. For example, a suitable DBMS may include instructions for adding or deleting database records, executing searches (e.g., SQL queries), executing “trigger” or other actions contingent upon changes in the database, performing memory management and storage optimization operations (e.g., implementing RAID techniques), maintaining user accounts with various levels of privilege or access, and managing user access such as user login authentication and authorization. User accounts' privileges and access might also be provided by a third party, such as a federated identity management service utilizing the Identity Assurance Framework standard.

FIG. 4 is a schematic representation of hardware elements that may be implemented in storing data elements in accordance with exemplary embodiments of the disclosed database encryption system. Storing one or more data elements in a location associated with an IP address (step 1200) may involve storing data on a remote server (step 1210), CPU (step 1220), and/or other computer readable media (step 1230). Storing of data at these types of remote locations may be performed using various techniques for transferring data to remote locations, such as by HTTP, FTP, or SOAP protocols. Data may further be transported using a reliable transport protocol, such as TCP (e.g., in the event that data is stored at only one location, or using an unreliable transport protocol, such as UDP (e.g., in the event that data may be replicated across multiple locations and it is not essential that all locations receive copies of the data).

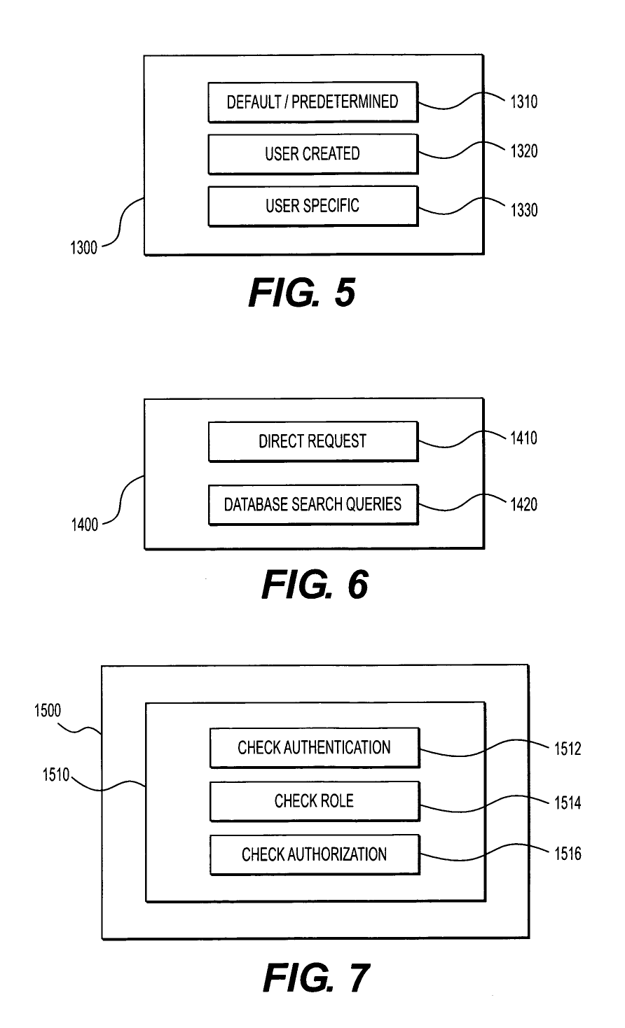

FIG. 5 is a schematic representation of exemplary processes by which references may be stored in fields of a database in accordance with exemplary embodiments of the disclosed database encryption system. Storing references, in each field of the database (step 1300) may include storing IP addresses as the references, wherein the IP addresses correspond with the remotely stored data elements. Some exemplary disclosed methods of database encryption may include associating a human readable reference ID with one or more of the data elements and displaying the reference ID to users instead of the IP address with which the one or more data elements is associated. In some embodiments, the human readable reference ID may be established according to a default or predetermined value. (Step 1310.) For example, the reference ID may be set as the name of the data field in which it is stored, such as, “Name,” “Age,” etc. In some embodiments the reference ID may be created by the user (step 1320), e.g., in a similar manner to creating a user ID.

Further, in some embodiments, the reference ID may be user specific. (Step 1330.) For example, for information stored with respect to a database record for an individual person, each reference ID could begin with the person's name, e.g., “John's Age.” As with displaying an IP address, where clicking on the IP address attempts to access the data stored at that IP address, clicking on a reference ID entitled “John's Age” may also attempt to access data stored regarding John's age, except the user will have a more clear indication of what the data is that they are trying to access. Associating reference IDs with the IP address references may be performed using a number of techniques, such as utilizing a straight numerical index in which consecutive IP addresses or IDs may align with memory addresses, thus allowing for fast location of information within memory by mathematical translation. Such association may alternatively be accomplished using various hash functions, for example when either IDs or IP addresses are not consecutive. As noted above, non-consecutive IP addresses would provide greater security assurance.

FIG. 6 is a schematic representation of exemplary processes involved in retrieving a reference stored in a database field. Retrieving the reference responsive to a request received from a user (step 1400) may, in some embodiments, include responding to direct requests from users (step 1410). For example, users may input one or more pieces of information associated with a particular record (e.g., an employee file), which may retrieve one or more data fields stored as part of that record and the references stored in those data fields. In some embodiments, the references may be retrieved in response to search queries. (Step 1420.) For example, a user may query a database for all employees who were hired in the year 2007. The search results may be displayed as a list of data fields each corresponding with an employee name. The display may include the references stored in the fields. In order to find out who each of the listed employees is, a user would then click on the reference to retrieve the employee's name and possibly other data regarding the employee, depending on the role and authority of the user. Retrieving references may be performed using SQL queries, guided user data entry sequences, regular expressions, boolean operators, etc. The database may further convert any one of the foregoing search methods into another.

FIG. 7 is a schematic representation of exemplary processes invoked by engaging a security layer around a data element. Engaging a security layer around the data element (step 1500) may, in some embodiments, include performing at least one security check according to a security protocol (step 1510). Performing at least one security check may include checking an authentication status of the user requesting to access the data element (step 1512), checking a role of the user requesting to access the data element (step 1514), and checking an authorization status of the user requesting to access the data element (step 1516). In some embodiments, performing the security checks may be executed by the local system that hosts the database. Additionally or alternatively, security checks may be executed by remote systems at trusted federated identity servers and/or by remote systems at which the data elements are stored. Security checks may, for example, require that a user provide a user ID and password. In some embodiments, security checks at remote systems may be satisfied by credentials that authenticate the user based on the user's prior login to that system. Security checks may utilize public/private key encryption techniques whereby the user is required to demonstrate rights to access data by providing a key or digital certificate, or, in high security environments, a biometric proof of identity.

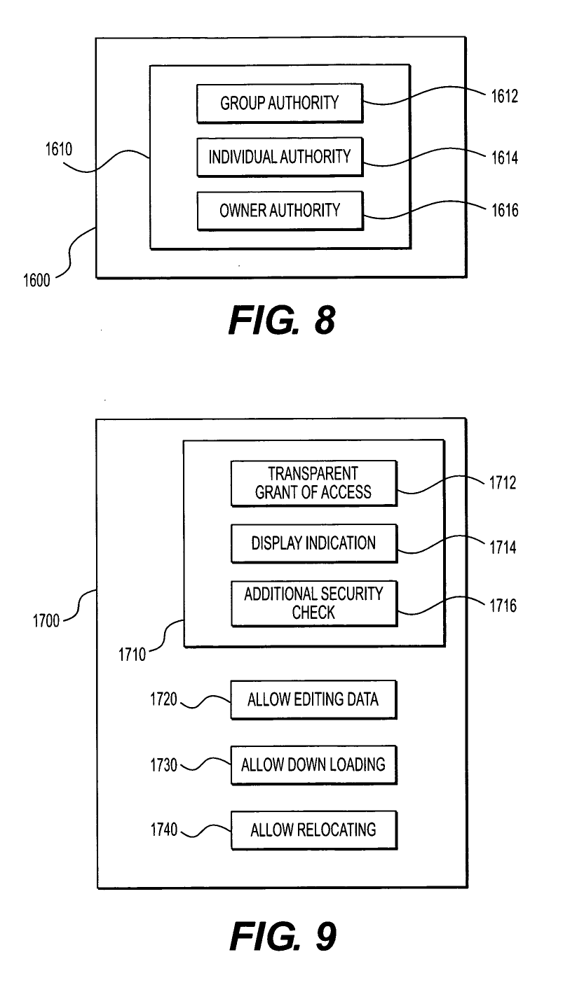

FIG. 8 is a schematic representation of exemplary processes involved in determining whether to grant access to a data element. Determining whether to grant access to the data element (step 1600) may include assessing whether the authority of the user includes rights to access the requested data (step 1610). There are several types of authority users may have to access data consistent with embodiments of the present invention. For example, the disclosed system may be configured to assess whether a user has group authority (step 1612), e.g., by virtue of being a member of a group of users authorized to access the data, such as a doctor, registered nurse or authorized government agency employee. In some embodiments, the disclosed system may evaluate whether the user has individual access. (Step 1614.) Further, the disclosed system may be configured to assess whether a user has ownership authorization, e.g., as the owner of the data or the owners' agent. (Step 1616.) Performing these evaluations may be executed, for example, by querying a separate user database or federated identity management service that stores unique identifiers for users or process IDs, along with roles associated with each user or groups to which various users belong.

FIG. 9 is a schematic representation of exemplary processes involved in granting access to a data element. Granting access to the data element if the user requesting access to the data element satisfies the at least one security check (step 1700) may be performed in a number of different ways. Granting access may be performed by, for example, displaying data (step 1710), allowing the user to edit the data (step 1720), allowing the user to download the data (step 1730), allowing the user to relocate the data (step 1740), e.g., to a different IP address, etc. Performing these functions may involve utilizing semaphores, memory locks, audit logs or other programmatic techniques to ensure atomic operations and guaranteed rollback in the event of incomplete transactions.

In some embodiments, granting access may be performed in a manner such that the transition from the access attempt to the grant of access, including execution of the security check, is imperceptible to the user. (Step 1712.) In some embodiments, the granting of access and/or the security check may be performed along with some kind of display indicating that these functions are being executed. (Step 1714.) For example, a message may appear on the display stating “Security Check in Progress,” or a similar message. In certain embodiments, the one or more security checks discussed above and/or an additional security check may be performed upon requesting access to the data. (Step 1716.) For example, an interactive security check, such as requiring a login ID and password, may be imposed upon the user prior to being granted access to the data. In such embodiments, additional authentication/authorization may be required based on, for example, the sensitivity of the data requested and/or the location where the data is stored. These displays and interactive security checks may be performed by consulting third party security vendors to provide user validations or digital certificate authentication. Security checks may additionally be run through additional entities charged with maintaining user privileges or levels of access for sensitive data, such as federated identity management service providers, government agencies or military departments in charge of clearance records.

Retrieving data from certain remote locations, or from multiple remote locations, may take a long time, relatively speaking in terms of computing time. Accordingly, certain embodiments of the disclosed system may be suitable for applications involving archiving data that is not frequently accessed. It is contemplated, however, that database query applications may quickly access data, even when stored across multiple locations.

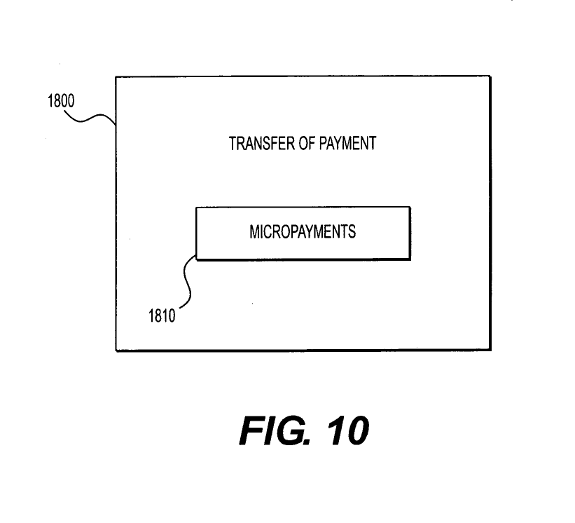

FIG. 10 is a schematic representation of exemplary processes involved in transferring payments related to use of the disclosed database encryption system. In some embodiments, the disclosed method of database encryption may include transferring a payment to an entity who hosts one or more data elements on behalf of an entity who maintains the database with which the one or more hosted data elements are associated. (Step 1800.) In some embodiments, transferring payments may be performed using a micropayment system. (Step 1810.) Transferring payments for data storage may also be performed using automated clearing house (ACH) or escrow entities.

For purposes of this disclosure, certain disclosed features are discussed in the alternative. However, it is contemplated that, to the extent possible, the various features disclosed herein may be implemented together in any of the disclosed, exemplary embodiments. Accordingly, differing features disclosed herein are not to be interpreted as being mutually exclusive to different embodiments unless explicitly specified herein or such mutual exclusivity would be readily understood, by one of ordinary skill in the art, to be inherent in view of the nature of the given features.

It must be noted that, as used herein and in the appended claims, the singular forms “a”, “an,” and “the” include plural referents unless the context clearly dictates otherwise. While the presently disclosed device and method have been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step, or steps to the objective, spirit, and scope of the present invention. Other embodiments of the invention will be apparent to those skilled in the art from consideration of the specification and practice of the invention disclosed herein. It is intended that the specification and examples be considered as exemplary only.

What is claimed is:

1. A method for database encryption, comprising:
maintaining a database having fields;
storing one or more data elements in a location associated with an Internet Protocol (IP) address, wherein the IP address is 128 bits or greater and wherein the location of the IP address is remote from the location at which the database is maintained;
storing, in at least one field of the database, a reference including an IP address corresponding with at least one of the one or more data elements;
retrieving the reference responsive to a request received from a user;
engaging a security layer around the at least one data element corresponding with the reference, including performing at least one security check according to a security protocol; and
determining whether to grant access to the at least one data element corresponding to the reference based on the security protocol.

2. The method of claim 1, wherein the IP address is in accordance with Internet Protocol version 6 (IPv6).

3. The method of claim 1, wherein the remote location in which the one or more data elements are stored resides behind a Network Address Translation (NAT) gateway.

4. The method of claim 1, wherein the security protocol is based on one or more directives including rules based on the user's:
role;
authority; or
credentials.

5. The method of claim 1, wherein the security layer is based on XML.

6. The method of claim 5, wherein the security layer includes a Security Assertion Markup Language (SAML) wrapper.

7. The method of claim 1, wherein the performing at least one security check includes one or more of the following:
checking a role of the user requesting access to the data element; and
checking an authorization status of the user requesting access to the data element; and
checking an authentication status of the user requesting access to the data element.

8. The method of claim 7, further including granting access to the data element when the user requesting access to the data element satisfies the at least one security check.

9. The method of claim 8, wherein, when the user satisfies the at least one security check, the granting of access to the data element is performed in a manner such that the transition from the access attempt to the grant of access, including execution of the security check, is imperceptible to the user.

10. The method of claim 1, further including:
associating a human readable reference ID with one or more of the data elements; and
displaying the reference ID to users instead of the IP address with which the one or more data elements is associated.

11. The method of claim 1, further including:
transferring a payment to an entity who hosts one or more data elements on behalf of an entity who maintains the database with which the one or more hosted data elements are associated.

12. A database encryption system, comprising:
a memory having program code stored therein; and
a processor operatively connected to said memory for carrying out instructions in accordance with said stored program code;
wherein said program code includes instructions, executable by said processor, for:
maintaining a database having fields;
storing one or more data elements each in a location associated with an Internet Protocol (IP) address, wherein the IP address is 128 bits or greater and wherein the location of the IP address is remote from the location at which the database is maintained;
storing, in at least one field of the database, a reference including an IP address corresponding with at least one of the one or more data elements;
retrieving the reference responsive to a request received from a user;
engaging a security layer around the at least one data element corresponding with the reference, including performing at least one security check according to a security protocol; and
determining whether to grant access to the data element corresponding to the reference based on the security protocol.

13. The system of claim 12, wherein the IP address is in accordance with Internet Protocol version 6 (IPv6).

14. The system of claim 12, wherein the location in which the one or more data elements are stored reside behind a Network Address Translation (NAT) gateway.

15. The system of claim 12, wherein the security protocol is based on one or more directives including rules based on the user's:
role;
authority; or
credentials.

16. The system of claim 12, wherein the security layer is based on XML.

17. The system of claim 16, wherein the security layer includes a Security Assertion Markup Language (SAML) wrapper.

18. The system of claim 12, wherein the performing at least one security check includes one or more of the following:
checking a role of the user requesting to access the data element;
checking an authorization status of the user requesting to access the data element; and
checking an authentication status of the user requesting to access the data element.

19. The system of claim 18, wherein the program code further includes instructions for granting access to the data element if the user requesting to access the data element satisfies the at least one security check.

20. The system of claim 19, wherein, when the user satisfies the at least one security check, the granting of access to the data element is performed in a manner such that the transition from the access attempt to the grant of access, including execution of the security check, is imperceptible to the user.

21. The system of claim 12, wherein the program code further includes instructions for:
associating a human readable reference ID with one or more of the data elements; and
displaying the reference ID to users instead of the IP address with which the one or more data elements is associated.

22. The system of claim 12, wherein the program code further includes:
instructions for transferring a payment to an entity who hosts one or more data elements on behalf of an entity who maintains the database with which the one or more hosted data elements are associated.

23. A method for database encryption, comprising:
maintaining a database having fields;
storing one or more data elements in a location associated with an Internet Protocol (IP) address, wherein the IP address is 128 bits or greater and wherein the location of the IP address is remote from the location at which the database is maintained;
storing, in at least one field of the database, a reference including an IP address corresponding with at least one of the one or more data elements;
retrieving the reference responsive to a request received from a user;
engaging a security layer around the at least one data element corresponding with the reference, including performing at least one security check according to a security protocol;
determining whether to grant access to the at least one data element corresponding to the reference based on the security protocol; and
granting access to the data element when the user requesting access to the data element satisfies the at least one security check;
wherein, when the user satisfies the at least one security check, the granting of access to the data element is performed in a manner such that the transition from the access attempt to the grant of access, including execution of the security check, is imperceptible to the user.
